(19) United States
(12) Patent Application Publication
(10) Pub. No.: US 2024/0144210 A1
(43) Pub. Date: May 2, 2024

(54) METHOD AND SYSTEM OF OPTIMIZING BUYER AND SUPPLIER COMMUNICATIONS

(71) Applicant: Mastercard International Incorporated, Purchase, NY (US)

(72) Inventors: Srinivasan CHANDRASEKHARAN, Princeton, NJ (US); Ganesh Nagendra PRASAD, Stamford, CT (US); Ross HARRIS, Stamford, CT (US); Alonso ARAUJO, New York, NY (US); Anubha PANDEY, Bikaner (IN); Deepak BHATT, Dehradun (IN); Aman GUPTA, Chandauli (IN); Tanmoy BHOWMIK, Bangalore (IN)

(21) Appl. No.: 17/973,679

(22) Filed: Oct. 26, 2022

(51) Int. Cl. G06Q 20/10

(52) U.S. Cl. CPC G06Q 20/102

(57) ABSTRACT

A method for optimizing invoice payments according to supplier and buyer controls includes: receiving one or more received data message including invoice data, a buyer identification value, a supplier identification value, and a plurality of buyer optimization priorities, wherein the invoice data is associated with an invoice and includes an invoice amount and due date; identifying a plurality of supplier controls associated with the supplier identification value; identifying one or more buyer preferences associated with the buyer identification value; determining an optimal payment schedule for one or more payment transactions for the invoice based on the invoice data, the buyer optimization priorities, the plurality of supplier controls, and the one or more buyer preferences; transmitting a transmitted data message including the determined optimal payment schedule.

### FIELD

The present disclosure relates to optimizing buyer and supplier communications, specifically for determining optimal payment schedules for invoices based on buyer and supplier controls and preferences.

### BACKGROUND

In the world of commerce, it can be difficult for buyers and suppliers to communicate in an efficient and timely fashion regarding payments and fulfillment of invoices. Each buyer and supplier can be different in terms of the payment methods they are willing to use, their desired schedules for payment, the fees they are willing to accept and pay, and what concessions they can provide if the other party uses a preferred payment method or timeline. In a single buyer-supplier relationship there can be dozens of possibilities for payment of a single invoice with regards to timing and payment method. Currently there are no systems available to buyers or suppliers to facilitate the optimal course of payment among those possibilities.

As a result, a buyer must spend time and effort determining the best course of action for payment for each invoice among the various options. In cases where a buyer can have hundreds or more invoices with a single supplier, and even further have hundreds of different supplier relationships, the act of determining how and when to pay invoices can require a significant amount of staff. Thus, there is a need for a technological system that can optimize the payment of invoices that satisfies controls and preferences for both buyers and suppliers in an automated and easy access process that can provide greater efficiency and lack of error than traditional, manual methods.

### SUMMARY

The present disclosure provides a description of systems and methods for optimizing invoice payments according to supplier and buyer controls. A buyer can supply invoice data for an invoice to be fulfilled along with identifiers for the buyer and the supplier associated with the invoice. Using the identifiers, a processing server can identify supplier controls, which can include accepted payment methods, fees associated with each, acceptable payment dates, and discounts offered by the supplier for each payment method and/or payment date. The processing server can also identify buyer preferences, such as if the buyer prefers a specific payment method, prefers the greatest discount, or prefers the longest timeline to make the payment. The processing server then determines an optimal payment schedule for at least the newly submitted invoice taking into account the supplier controls and buyer preferences for one or more payments that fulfills the invoice. The processing server then provides the recommendation to the buyer, which can then proceed to fulfill the invoice accordingly. In some embodiments, the processing server can automatically initiate the payment(s) according to the determined optimal schedule.

A method for optimizing invoice payments according to supplier and buyer controls includes: receiving, by a receiver of a processing server, one or more received data messages including at least invoice data, a buyer identification value, a supplier identification value, and a plurality of buyer optimization priorities, wherein the invoice data is associated with an invoice and includes at least an invoice amount and due date; identifying, by a processor of the processing server, a plurality of supplier controls associated with the supplier identification value; identifying, by the processor of the processing server, one or more buyer preferences associated with the buyer identification value; determining, by the processor of the processing server, an optimal payment schedule for one or more payment transactions for the invoice based on at least the invoice data, the buyer optimization priorities, the plurality of supplier controls, and the one or more buyer preferences; transmitting, by a transmitter of the processing server, a transmitted data message including the determined optimal payment schedule.

A system for optimizing invoice payments according to supplier and buyer controls includes: a receiver of a processing server receiving one or more data messages including at least invoice data, a buyer identification value, a supplier identification value, and a plurality of buyer optimization priorities, wherein the invoice data is associated with an invoice and includes at least an invoice amount and due date; a processor of the processing server identifying a plurality of supplier controls associated with the supplier identification value, identifying one or more buyer preferences associated with the buyer identification value, and determining an optimal payment schedule for one or more payment transactions for the invoice based on at least the invoice data, the buyer optimization priorities, the plurality of supplier controls, and the one or more buyer preferences; and a transmitter of the processing server transmitting a transmitted data message including the determined optimal payment schedule.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for optimizing invoice payments using buyer and supplier controls in accordance with exemplary embodiments.

FIG. 2 is a block diagram illustrating a processing server in the system of FIG. 1 for optimizing invoice payments using buyer and supplier controls in accordance with exemplary embodiments.

FIG. 3 is a flow diagram illustrating a process for optimizing invoice payments using buyer and supplier controls in the system of FIG. 1 in accordance with exemplary embodiments.

FIG. 4 is a flow chart illustrating an exemplary method for optimizing invoice payments according to supplier and buyer controls in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

System for Optimizing Invoice Payments Using Controls

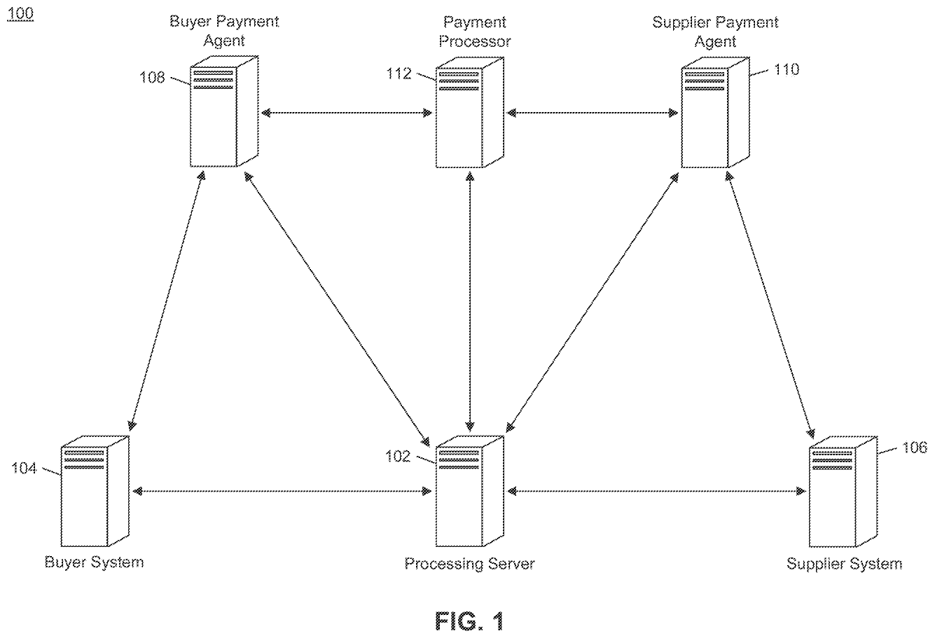

FIG. 1 illustrates a system 100 that determines optimal payment schedules for invoices according to invoice data and buyer and supplier controls and preferences.

The system 100 can include a processing server 102. The processing server 102, discussed in more detail below, can be configured to determine optimal payment schedules for invoices in a buyer and supplier relationship. In the system 100, a buyer system 104 can submit a data message to the processing server 102 using a suitable communication network and method. The data message can include invoice data for one or more invoices, a buyer identification value, and a supplier identification value. The buyer identification value can be a unique value associated with the buyer system 104 used for the identification of data associated therewith, such as an identification number. The supplier identification value can be a unique value associated with a supplier system 106 used for the identification of data associated therewith, such as an identification number. The invoice data can include any data associated with the related invoice that can be used in determining the optimal payment schedule, such as the payment amount and due date, and can additionally include any other suitable data, such as an invoice number or other identifier.

The processing server 102 can receive the data message from the buyer system 104 and identify the data included therein. The processing server 102 can use the supplier identification value to identify one or more supplier controls. The supplier controls can be provided by the supplier system 106 associated with the supplier identification value. Supplier controls can include any controls the supplier would like on payments to be made to fulfill an invoice. Supplier controls can include, for example, rail controls (e.g., payment methods accepted/prohibited by the supplier system 106), discount controls (e.g., percentage or flat rate discounts, which can be specific to payment methods or times), fee controls (e.g., fees imposed for specific payment methods and/or times), time controls (e.g., limits on when a payment can be accepted), amount controls (e.g., upper or lower limits on amounts that can be paid using specific payment methods), relationship controls (e.g., controls specific to the buyer system 104), etc. In some embodiments, the supplier system 106 can provide supplier controls to the processing server 102 during an onboarding process. In such embodiments, the processing server 102 can identify the supplier controls using the supplier identification value from a local database or other accessible data storage. In other embodiments, the processing server 102 can electronically transmit a request message to the supplier system 106 (e.g., identified using the supplier identification value) that requests supplier controls for the received invoice.

The processing server 102 can use the buyer identification value to identify one or more buyer preferences for the buyer system 104. In some embodiments, the buyer system 104 can previously provide the buyer preferences to the processing server 102, such as during an onboarding process, where the processing server 102 can identify the buyer preferences using the buyer identification value from a local database or other accessible data storage. In other embodiments, the processing server 102 can request the buyer preferences from the buyer system 104 after receiving the data message. In some cases, the data message can further include the buyer preferences. The buyer preferences can include a default payment method and/or default payment date.

The data message and/or buyer preferences can further include one or more buyer optimization priorities. Buyer optimization priorities can be a prioritized list of considerations by the buyer system 104 to be used in determining the optimal payment schedule. For instance, a buyer system 104 can be interested in maximizing a discount, minimizing the total payment, minimizing fees, having the latest payment date, having the earliest payment date, etc. In some cases, buyer optimization priorities can be hierarchal, such as where the buyer optimization priorities are in an ordered list of highest priority to lowest priority. For example, maximum discount can be first priority, earliest payment date can be second priority, and minimized fees can be third priority. If two payment methods provide the same discount, then whichever can be paid earlier will be selected even if it has a higher fee associated therewith. In other cases, a formula-based approach can be used for the buyer optimization priorities, such as using a combination of invoice amount, fees, and discount to determine the lowest overall payment.

Once the data has been received and identified, the processing server can determine an optimal payment schedule for the invoice. The optimal payment schedule can be determined based on a combination of the invoice data, the supplier controls, the buyer preferences, and the buyer optimization priorities. In an example, the buyer system 104 can submit an invoice with a payment amount of $50,000 that is submitted on March 10th and due for payment on June 8th. The supplier system 106 can provide supplier controls for time (e.g., payment made after the specified number of days) and discount (e.g., both percentage and flat amount) as represented in Table 1:

TABLE 1
Supplier Discount/Time Controls

| Payment Method | 30 Days | 60 Days | 90 Days |
|---|---|---|---|
| Credit | 5%, $10 | 3%, $5 | 0%, $0 |
| Wire Transfer | 1%, $5 | 1%, $0 | 0%, $0 |
| Real Time Payment | 5%, $10 | 3%, $5 | 0%, $0 |

The processing server 102 can also take into account fees that can be associated with each possible payment method, such as fees represented in Table 2:

TABLE 2
Payment Method Costs

| Payment Method | % Fee | Flat Fee |
|---|---|---|
| Credit | 2% | $200 |
| Wire Transfer | 1% | $300 |
| Real Time Payment | 1% | $150 |

In the example, the buyer system 104 can provide the following hierarchal buyer optimization priorities: (1) maximum discount, (2) minimum method cost, and (3) latest payable date, where a tiebreaker is selected using the buyer preference of the buyer system's default preferred payment method (e.g., credit). In this example, the processing server 102 can determine that the optimal payment schedule is to make one payment using credit at 30 days from the invoice date as it results in the maximum discount of $2,510, as credit is the tiebreaker for the buyer system 104 when both credit and real time payment offer the same discount.

In cases where a formula-based approach can be used for buyer optimization priorities, the buyer system 104 can have a priority of maximizing the discount minus the cost of the transaction (e.g., based on payment method costs). Using this type of priority, the processing server 102 would determine, in the above example, an optimal payment schedule of a single payment using real time payment paid on 30 days from the invoice data as real time payment has a smaller cost associated therewith and thus has the maximum of discount minus cost.

Once the optimal payment schedule has been determined, the processing server 102 can electronically transmit a recommendation in a data message to the buyer system 104 with the optimal payment schedule included therein. The buyer system 104 can then fulfill the invoice as recommended. For instance, in the above example, the buyer system 104 can initiate a credit payment to the supplier system 106 using an appropriate payment processor 112 for $48,140 (the invoice amount minus discount plus method costs) on April 9 (30 days from the invoice date).

In some embodiments, the processing server 102 can be configured to initiate fulfillment of the invoice using the determined optimal payment schedule. In some cases, the buyer system 104 can respond to the recommendation by providing the processing server 102 with permission and/or instructions to proceed with payment satisfying the provided optimal payment schedule. In such cases, the buyer system 104 can provide (e.g., in the response or previously during onboarding) the processing server 102 with payment account details to initiate the determined optimal payment(s). For instance, in the above example, the buyer system 104 can have provided the processing server 102 with card details for a payment card for use in funding a credit transaction during onboarding, which the processing server 102 can use in initiating a new credit transaction for payment of $48,140 to the supplier system 106 on April 9.

In other cases, the processing server 102 can initiate fulfillment automatically. For instance, the buyer system 104 can provide the processing server 102 with permission (e.g., during onboarding or the initially submitted data message) to automatically fulfill the invoice based on the determined optimal payment schedule. In such cases, the processing server 102 can still provide the recommendation to the buyer system 104. In the above example, the processing server 102 would automatically initiate a credit transaction from the buyer system 104 to the supplier system 106 on April 9 for $48,140. Initiation of a payment transaction can include the submission of a transaction message or other suitable transmission to a payment processor 112 by the processing server 102. In some cases, such communications can utilize specialized communication systems, such as payment rails associated with a payment network. The formatting of such messages and data included therein can depend on the type of transaction and requirements of the payment processor 112, which can vary, such as between credit transactions, wire transfers, debit transactions, transactions using Real Time Payment, etc.

In some embodiments, the processing server 102 can determine an optimal payment schedule for multiple invoices at once. In such an embodiment, the buyer system 104 can submit new data messages for each invoice associated with a single supplier system 106. The processing server 102 can be configured to determine an optimal payment schedule based on the buyer optimization priorities that can fulfill each of the plurality of invoices. In some cases, the processing server 102 can begin the process when requested by the buyer system 104 (e.g., as explicitly requested or at a predetermined period of time as indicated by the buyer system 104, such as monthly). In other cases, the processing server 102 can generate a new recommendation each time a new invoice is received, where the buyer system 104 can determine when to proceed with payment(s) according to the optimal payment schedule as determined by the processing server 102.

In an example, the buyer system 104 can supply two invoices to the processing server 102 that are associated with the supplier system 106: a first invoice (Inv1) for $10,000 with an invoice date of September 1 and a due date of November 30, and a second invoice (Inv2) for $5,000 with an invoice date of September 5 and a due date of December 4. The buyer optimization priority can be to maximize the savings (e.g., the greater of the discount minus the transaction cost). The processing server 102 can determine the maximum using the following equation:

$$\sum [ {\sum }_{j = 1}^{{n}_{col}} ( P * D ) [ : , j ] - Ceiling ( \frac{{INV}_{amt} \times D}{UB} ) * T ]$$

Where n is the number of invoices, P is the matrix for the discount minus costs of each payment possibility (with a row for each invoice and columns are time/method combinations), D is the decision matrix for each payment possibility, INVₐₘₜ is the amount of each invoice, T is transaction cost, and UB is an upper bound for an amount control (e.g., where amounts above the upper bound cannot use that payment method). Using the same supplier controls and payment costs from the first example above, detailed in Tables 1 and 2, the processing server 102 can determine that the optimal payment schedule is a single payment to be made on October 5 to cover both invoices. Paying each invoice at 30 days would result in a savings of $260 for Inv1 and $60 for Inv2, but a single payment at 30 days of Inv2 (which would fall in the 60-day window for Inv1) would result in a savings of $265 due to the savings in costs for a single payment. Thus, the processing server 102 would recommend a single payment of $14,735 on October 5 to the buyer system 104.

In some embodiments, the system 100 can include a buyer payment agent 108 and/or a supplier payment agent 110. The buyer payment agent 108 and supplier payment agent 110 can be agents that operate on behalf of the buyer system 104 and supplier system 106, respectively, to perform one or more actions associated therewith as discussed herein. For instance, the buyer payment agent 108 can submit the data message to the processing server 102, receive the recommendation from the processing server 102, initiate payment with the payment processor 112, etc. Similarly, the supplier payment agent 110 can receive payment notifications, provide supplier controls, receive invoice data, etc.

The methods and systems discussed herein provide for determining optimized payment schedules for fulfilling invoices using a combination of buyer preferences and optimization priorities and supplier controls that take into account the invoice data, costs, discounts, etc. By considering all of the relevant variables the processing server 102 can determine an optimal payment schedule faster and more efficiently than traditional methods and with significantly less error. Additionally, the processing server 102 can be configured to automatically initiate the payment(s) as determined by the optimal payment schedule, which can further increase the efficiency and convenience for buyer systems 104, and result in easier and timelier fulfillment for supplier systems 106. Furthermore, if multiple invoices are considered, the processing server 102 can determine an optimal payment schedule to fulfill all of the invoices at once, which can provide significant savings to buyer systems 104 and reduce the overall number of transactions processed by payment processors 112, resulting in less congested networks that can therefore provide faster communications.

### Processing Server

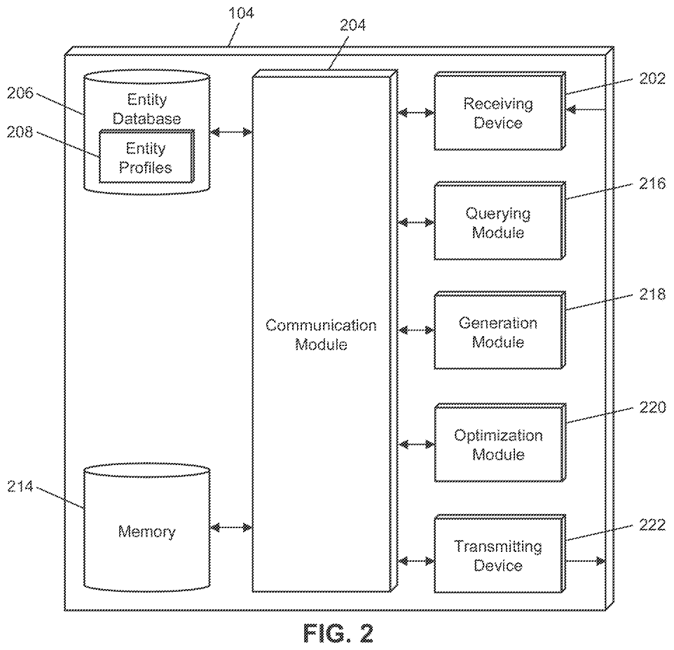

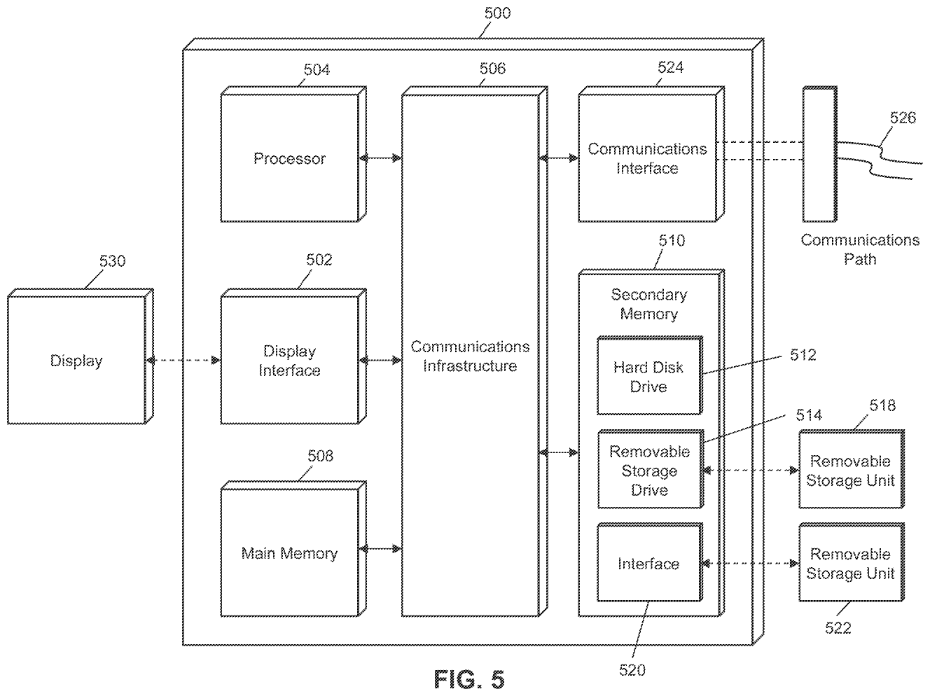

FIG. 2 illustrates an embodiment of a processing server 102. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, additional components of the system 100, such as the buyer system 104, supplier system 106, buyer payment agent 108, supplier payment agent 110, and payment processor 112 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from buyer systems 104, supplier systems 106, buyer payment agents 108, supplier payment agents 110, payment processors 112, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by buyer systems 104 and buyer payment agents 108 that can be superimposed or otherwise encoded with data messages that can include invoice data, buyer identification values, supplier identification values, buyer preferences, buyer optimization priorities, etc. The receiving device 202 can also be configured to receive data signals electronically transmitted by supplier systems 106 and supplier payment agents 110 that can be superimposed or otherwise encoded with data messages that can include supplier controls. The receiving device 202 can also be configured to receive data signals electronically transmitted by payment processors 112, which can be superimposed or otherwise encoded with data regarding processed payment transactions.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, optimization module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an entity database 206. The entity database 206 can be configured to store one or more entity profiles 208 using a suitable data storage format and schema. The entity database 206 can be a relational database that utilizes structured query language for the storage, identification, modifying, updating, accessing, etc. of structured data sets stored therein. Each entity profile 208 may be a structured data set configured to store data related to an entity registered in the system 100, such as a buyer system 104, supplier system 106, buyer payment agent 108, supplier payment agent 110, etc. An entity profile 208 can include, for example, a buyer identification value, supplier identification value, supplier controls, buyer optimization priorities, buyer preferences, payment account data, invoice data, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, transaction messages formatting rules, etc.

The processing server 102 can include a querying module 216. The querying module 216 can be configured to execute queries on databases to identify information. The querying module 216 can receive one or more data values or query strings and can execute a query string based thereon on an indicated database, such as the entity database 206 of the processing server 102 to identify information stored therein. The querying module 216 can then output the identified information to an appropriate engine or module of the processing server 102 as necessary. The querying module 216 can, for example, execute a query on the entity database 206 to identify an entity profile 208 that includes a supplier identification value received in data message from a buyer payment agent 108 to identify the supplier controls included therein for use in determining an optimal payment schedule.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, recommendation messages, transaction messages, payment instructions, requests for data, etc.

The processing server 102 can also include an optimization module 220. The optimization module 220 can be configured to perform optimizations for the processing server 102 as part of the functions discussed herein. The optimization module 220 can receive instructions as input, which can also include data to be used in performing an optimization, can perform an optimization as requested, and can output a result of the optimization to another module or engine of the processing server 102. The optimization module 220 can, for example, be configured to determine optimal payment schedules for one or more invoices as discussed herein. The optimization module 220 can determine an optimal payment scheduled based on invoice data for one or more invoices, supplier controls, buyer preferences, and buyer optimization priorities. The optimization module 220 can use hierarchal priorities, a formula-based approach to priorities, or any other suitable method.

The processing server 102 can also include a transmitting device 222. The transmitting device 222 can be configured to transmit data over one or more networks via one or more network protocols. In some instances, the transmitting device 222 can be configured to transmit data to buyer systems 104, supplier systems 106, buyer payment agents 108, supplier payment agents 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to buyer systems 104 and buyer payment agents 108 that can be superimposed or otherwise encoded with data messages that can include requests for preferences or optimization priorities, requests for transaction account data, payment schedule recommendations, processed transaction notifications, etc. The transmitting device 222 can also be configured to electronically transmit data signals to supplier systems 106 and supplier payment agents 110, which can be superimposed or otherwise encoded with data messages that can include requests for supplier controls, processed transaction notifications, requests for transaction account data, etc. The transmitting device 222 can also be configured to electronically transmit data signals to payment processors 112 that can be superimposed or otherwise included with data messages that can include data sufficient for initiating one or more payment transactions, where such data can depend on the type of payment transaction, number of transactions, etc.

### Process for Determining an Optimal Payment Schedule

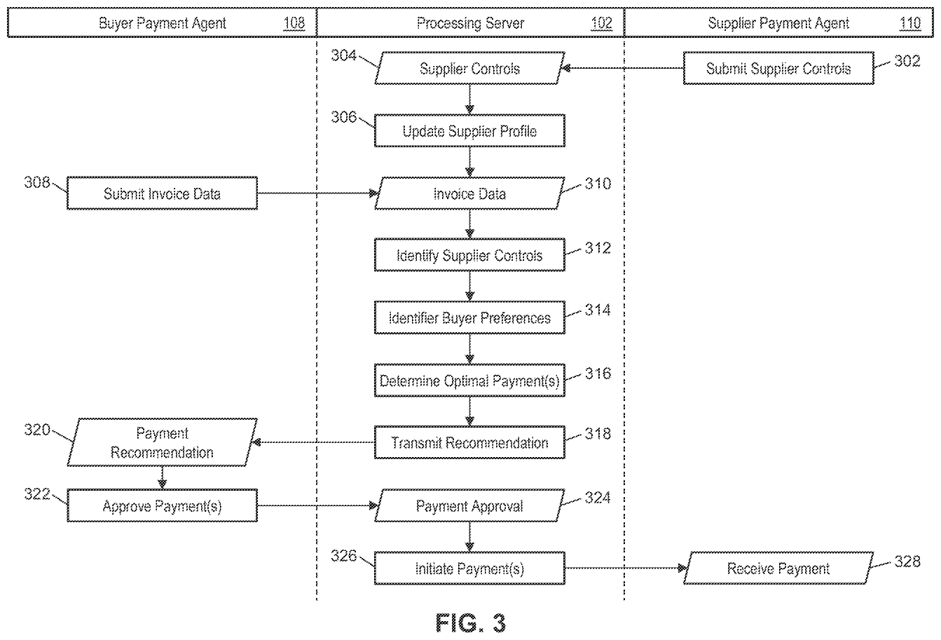

FIG. 3 illustrates a process 300 for determining an optimal payment schedule using buyer preferences, buyer optimization priorities, and supplier controls in the system 100.

In step 302, a supplier payment agent 110 can, on behalf of a supplier system 106, submit a plurality of supplier controls to the processing server 102 using a suitable communication network and method along with a supplier identification value associated with the supplier system 106. The plurality of supplier controls can include controls set by the supplier system 106 and/or supplier payment agent 110 for payments to be made thereto, such as specifying discounts, fees, payment method restrictions, etc. In step 304, the receiving device 202 of the processing server 102 can receive the supplier controls from the supplier payment agent 110. In step 306, the querying module 216 of the processing server 102 can execute a query on the entity database 206 of the processing server 102 to update the supplier controls in an entity profile 208 associated with the supplier system as identified using the supplier identification value.

In step 308, the buyer payment agent 108 can, on behalf of the buyer system 104, electronically transmit a data message to the processing server 102 using a suitable communication network and method that includes at least invoice data, a buyer identification value associated with the buyer system 104, and the supplier identification value. In some cases, the data message can further include buyer preferences and/or buyer optimization priorities. In step 310, the receiving device 202 of the processing server 102 can receive the data message from the buyer payment agent 108.

In step 312, the querying module 216 of the processing server 102 can execute a query on the entity database 206 of the processing server 102 to identify the entity profile 208 associated with the supplier system 106 using the supplier identification value received in the data message to identify the updated supplier controls stored therein. In step 314, the querying module 216 of the processing server 102 can execute another query on the entity database 206 of the processing server 102 to identify an entity profile 208 associated with the buyer system 104 using the buyer identification value received in the data message to identify any buyer preferences and/or buyer optimization priorities not included in the received data message.

In step 316, the optimization module 220 of the processing server 102 can determine an optimal payment schedule for one or more payments to fulfill the invoice based on at least the invoice data (e.g., invoice amount, invoice due date, etc.), the supplier controls, the buyer preferences, and the buyer optimization priorities. In some cases, the optimal payment schedule can be for only the invoice received in step 310. In other cases, the optimization module 220 can consider past unpaid invoices involving the buyer system 104 and supplier system 106 when determining an optimal payment schedule. The optimal payment schedule can include one or more payments to be made at a date and using a payment method as determined to be optimal based on the controls, preferences, and priorities, such as discussed above. In step 318, the transmitting device 222 of the processing server 102 can electronically transmit a data message to the buyer payment agent 108 using a suitable communication network and method that includes a recommendation of the optimal payment schedule.

In step 320, the buyer payment agent 108 can receive the recommendation of the optimal payment schedule from the processing server 102. The buyer payment agent 108 can (e.g., in consultation with the buyer system 104 or using past instructions provided thereby) determine that the optimal payment schedule is suitable and, in step 322, electronically transmit a data message to the processing server 102 that includes an approval of the recommended payment schedule using a suitable communication network and method. In step 324, the receiving device 202 of the processing server 102 can receive the approval from the buyer payment agent 108. In step 326, the transmitting device 222 of the processing server 102 can electronically transmit a transaction message to the appropriate payment processor 112 for the initiation of one or more payment transactions for amounts and on dates specified in the determined optimal payment schedule. In step 328, the supplier payment agent 110 may receive a notification (e.g., from the processing server 102, payment processor, a financial institution, etc.) of the payment made for the invoice. For instance, in one example, the payment transaction can include an identification number from the invoice data, which can be used by the supplier payment agent 110 to match the payment to the appropriate invoice(s).

### Exemplary Method for Optimizing Invoice Payments

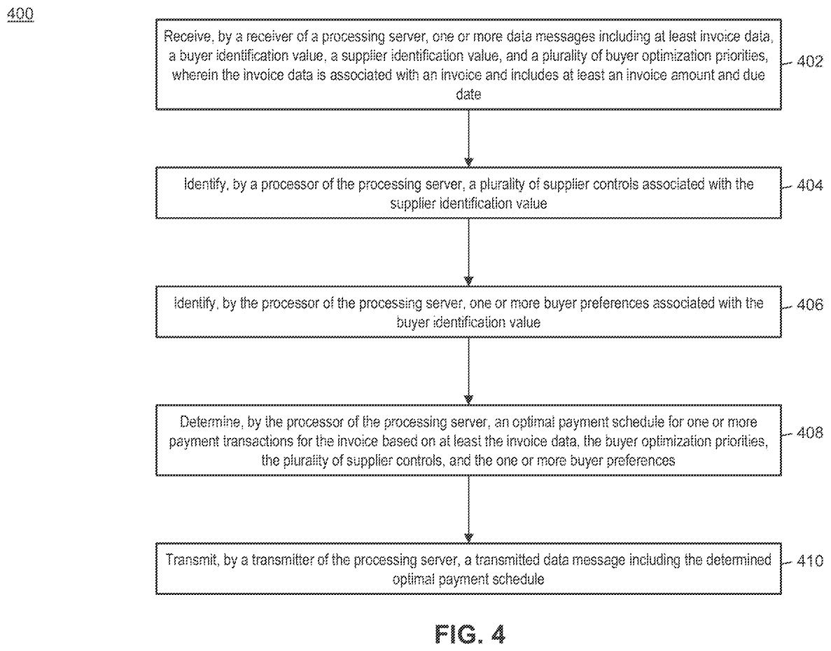

FIG. 4 illustrates a method 400 for the optimizing of invoice payments in accordance with buyer preferences, buyer optimization priorities, and supplier controls.

In step 402, a first data message (which can be one or more received data messages with at least buyer optimization priorities data previously stored for later use when an invoice is provided, or the buyer optimization priorities data can be provided with each invoice) can be received by a receiver (e.g., receiving device 202) of a processing server (e.g., processing server 102), where the one or more data messages includes at least invoice data, a buyer identification value, a supplier identification value, and a plurality of buyer optimization priorities, wherein the invoice data is associated with an invoice and includes at least an invoice amount and due date. In step 404, a plurality of supplier controls associated with the supplier identification value can be identified by a processor (e.g., querying module 216) of the processing server 102. In step 406, one or more buyer preferences associated with the buyer identification value can be identified by the processor (e.g., querying module 216) of the processing server.

In step 408, the processor (e.g., optimization module 220) of the processing server can determine an optimal payment schedule for one or more payment transactions for the invoice based on at least the invoice data, the buyer optimization priorities, the plurality of supplier controls, and the one or more buyer preferences. In step 410, a second data (e.g., transmitted data) message can be transmitted by a transmitter (e.g., transmitting device 222) of the processing server, the second data message including the determined optimal payment schedule.

In one embodiment, the method 400 can further include initiating, by the processor of the processing server, the one or more payment transactions for the invoice according to the optimal payment schedule. In some embodiments, the plurality of supplier controls can be stored in a database entry (e.g., entity profile 208) in a database (e.g., entity database 206) included in the processing server, the database entry further including the supplier identification value. In one embodiment, identifying the plurality of supplier controls can include: identifying, by the processor (e.g., querying module 216) of the processing server, a computing device (e.g., supplier system 106) associated with the supplier identification value; transmitting, by the transmitter of the processing server, a third data (e.g., another transmitted data) message to the identified computing device; and receiving, by the receiver of the processing server, a fourth (e.g., another received) data message from the identified computing device including the plurality of supplier controls.

In some embodiments, the one or more buyer preferences can be stored in a database entry in a database included in the processing server, the database entry further including the buyer identification value. In one embodiment, the one or more buyer preferences can be identified in the received first data message. In some embodiments, the method 400 can also include storing, in a database of the processing server, a plurality of invoice data sets, wherein each invoice data set includes at least the buyer identification value, the supplier identification value, and one or more invoice data values, wherein the one or more payment transactions is also for payment of invoices associated with each of the plurality of invoice data sets, and the optimal payment schedule is further determined based on the one or more invoice data values included in each of the plurality of invoice data sets. In one embodiment, the optimal payment schedule can be determined based on the buyer optimization priorities using one of: a hierarchal approach or a formula-based approach.

### Computer System Architecture

FIG. 5 illustrates a computer system 500 in which embodiments of the present disclosure, or portions thereof, can be implemented as computer-readable code. For example, the processing server 102 of FIGS. 1 and 2 and the buyer system 104, supplier system 106, buyer payment agent 108, supplier payment agent 110, and payment processor 112 of FIG. 1 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for optimizing invoice payments according to supplier and buyer controls. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for optimizing invoice payments according to supplier and buyer controls, comprising:
receiving, by a receiver of a processing server, one or more received data messages including at least invoice data, a buyer identification value, a supplier identification value, and a plurality of buyer optimization priorities, wherein the invoice data is associated with an invoice and includes at least an invoice amount and due date;
identifying, by a processor of the processing server, a plurality of supplier controls associated with the supplier identification value;
identifying, by the processor of the processing server, one or more buyer preferences associated with the buyer identification value;
determining, by the processor of the processing server, an optimal payment schedule for one or more payment transactions for the invoice based on at least the invoice data, the buyer optimization priorities, the plurality of supplier controls, and the one or more buyer preferences;
transmitting, by a transmitter of the processing server, a transmitted data message including the determined optimal payment schedule.

2. The method of claim 1, further comprising:
initiating, by the processor of the processing server, the one or more payment transactions for the invoice according to the optimal payment schedule.

3. The method of claim 1, wherein the plurality of supplier controls are stored in a database entry in a database included in the processing server, the database entry further including the supplier identification value.

4. The method of claim 1, wherein identifying the plurality of supplier controls includes:
identifying, by the processor of the processing server, a computing device associated with the supplier identification value;
transmitting, by the transmitter of the processing server, another transmitted data message to the identified computing device; and
receiving, by the receiver of the processing server, another received data message from the identified computing device including the plurality of supplier controls.

5. The method of claim 1, wherein the one or more buyer preferences are stored in a database entry in a database included in the processing server, the database entry further including the buyer identification value.

6. The method of claim 1, wherein the one or more buyer preferences are identified in the one or more received data messages.

7. The method of claim 1, further comprising:
storing, in a database of the processing server, a plurality of invoice data sets, wherein each invoice data set includes at least the buyer identification value, the supplier identification value, and one or more invoice data values, wherein
the one or more payment transactions is also for payment of invoices associated with each of the plurality of invoice data sets, and
the optimal payment schedule is further determined based on the one or more invoice data values included in each of the plurality of invoice data sets.

8. The method of claim 1, wherein the optimal payment schedule is determined based on the buyer optimization priorities using one of: a hierarchal approach or a formula based approach.

9. A system for optimizing invoice payments according to supplier and buyer controls, comprising:
a receiver of a processing server receiving one or more received data message including at least invoice data, a buyer identification value, a supplier identification value, and a plurality of buyer optimization priorities, wherein the invoice data is associated with an invoice and includes at least an invoice amount and due date;
a processor of the processing server
identifying a plurality of supplier controls associated with the supplier identification value,
identifying one or more buyer preferences associated with the buyer identification value, and
determining an optimal payment schedule for one or more payment transactions for the invoice based on at least the invoice data, the buyer optimization priorities, the plurality of supplier controls, and the one or more buyer preferences; and
a transmitter of the processing server transmitting a transmitted data message including the determined optimal payment schedule.

10. The system of claim 9, wherein the processor of the processing server initiates the one or more payment transactions for the invoice according to the optimal payment schedule.

11. The system of claim 9, further comprising:
a database of the processing server storing the plurality of supplier controls in a database entry, the database entry further including the supplier identification value.

12. The system of claim 9, further comprising:
a computing device associated with the supplier identification value, wherein identifying the plurality of supplier controls includes:
identifying, by the processor of the processing server, the computing using the supplier identification value,
transmitting, by the transmitter of the processing server, another transmitted data message to the identified computing device, and
receiving, by the receiver of the processing server, another received data message from the identified computing device including the plurality of supplier controls.

13. The system of claim 9, further comprising:
a database of the processing server storing the one or more buyer preferences are in a database entry, the database entry further including the buyer identification value.

14. The system of claim 9, wherein the one or more buyer preferences are identified in the one or more received data message.

15. The system of claim 9, further comprising:
a database of the processing server storing a plurality of invoice data sets, wherein each invoice data set includes at least the buyer identification value, the supplier identification value, and one or more invoice data values, wherein
the one or more payment transactions is also for payment of invoices associated with each of the plurality of invoice data sets, and
the optimal payment schedule is further determined based on the one or more invoice data values included in each of the plurality of invoice data sets.

16. The system of claim 9, wherein the optimal payment schedule is determined based on the buyer optimization priorities using one of: a hierarchal approach or a formula based approach.
